(19) United States
(12) Patent Application Publication
(10) Pub. No.: US 2026/0101419 A1
(43) Pub. Date: Apr. 9, 2026

(54) SYSTEMS AND METHODS FOR REDUCING NOISE FROM QUASI-RESONANT INDUCTION CONTROL

(71) Applicant: Haier US Appliance Solutions, Inc., Wilmington, DE (US)

(72) Inventor: Steven Michael Recio, Louisville, KY (US)

(21) Appl. No.: 18/906,916

(22) Filed: Oct. 4, 2024

(51) Int. Cl. H05B 6/06; H05B 6/04; H05B 6/12

(52) U.S. Cl. CPC H05B 6/062; H05B 6/04; H05B 6/1245

(57) ABSTRACT

An induction heating system for an induction cooking appliance is provided. The induction heating system includes a bus capacitor configured to receive direct current (DC) power. The induction heating system further includes a first inverter system operatively coupled to the bus capacitor, the first inverter system configured to energize a first coil based at least in part on the DC power. The induction heating system further includes a second inverter system operatively coupled to the bus capacitor, the second inverter system configured to energize a second coil based at least in part on the DC power. The first inverter system is further configured to at least partially discharge the bus capacitor based at least in part on a start-up time of the second inverter system.

### FIELD

Example aspects of the present disclosure relate generally to induction heating systems used, for instance, in induction cooking appliances, and more particularly to reducing noise from quasi-resonant induction control in an induction cooking appliance.

### BACKGROUND

Induction cooking appliances (e.g., induction cook-tops) heat conductive cookware by magnetic induction. An induction cooking appliance applies radio frequency current to a heating coil to generate a strong radio frequency magnetic field on the heating coil. When a conductive vessel, such as a pan, is placed over the heating coil, the magnetic field coupling from the heating coil generates eddy currents on the vessel, causing the vessel to increase in temperature.

### SUMMARY

Aspects and advantages of embodiments of the present disclosure will be set forth in part in the following description, or can be learned from the description, or can be learned through practice of the embodiments.

One example aspect of the present disclosure is directed to an induction heating system for an induction cooking appliance. The induction heating system includes a bus capacitor configured to receive direct current (DC) power. The induction heating system further includes a first inverter system operatively coupled to the bus capacitor, the first inverter system configured to energize a first coil based at least in part on the DC power. The induction heating system further includes a second inverter system operatively coupled to the bus capacitor, the second inverter system configured to energize a second coil based at least in part on the DC power. The first inverter system is further configured to at least partially discharge the bus capacitor based at least in part on a start-up time of the second inverter system.

Another example aspect of the present disclosure is directed to an induction heating system for an induction cooking appliance. The induction heating system includes a bus capacitor configured to receive direct current (DC) power. The induction heating system further includes a half-bridge (HB) inverter system operatively coupled to the bus capacitor, the HB inverter system configured to energize a first coil based at least in part on the DC power. The induction heating system further includes a quasi-resonant (QR) inverter system operatively coupled to the bus capacitor, the QR inverter system configured to energize a second coil based at least in part on the DC power. The HB inverter system is further configured to at least partially discharge the bus capacitor based at least in part on a start-up time of the QR inverter system.

Another example aspect of the present disclosure is directed to an induction cooking appliance. The induction cooking appliance includes one or more induction heating elements. The induction cooking appliance further includes an induction heating system. The induction heating system includes a bus capacitor configured to receive direct current (DC) power. The induction heating system further includes a first inverter system operatively coupled to the bus capacitor, the first inverter system configured to energize a first coil based at least in part on the DC power. The induction heating system further includes a second inverter system operatively coupled to the bus capacitor, the second inverter system configured to energize a second coil based at least in part on the DC power. The first inverter system is further configured to at least partially discharge the bus capacitor based at least in part on a start-up time of the second inverter system.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 illustrates a perspective view of an example induction cooking appliance according to example embodiments of the present disclosure;

FIG. 2 provides a block diagram of an example induction heating control system according to example embodiments of the present disclosure;

FIG. 3 depicts a schematic implementation of an example induction heating system according to example embodiments of the present disclosure;

FIG. 4 provides a schematic implementation of an example half-bridge (HB) inverter system according to example embodiments of the present disclosure;

FIG. 5 provides a schematic implementation of an example quasi-resonant (QR) inverter system according to example embodiments of the present disclosure; and

FIG. 6 provides a graphical representation of example signals of an induction heating system according to example embodiments of the present disclosure.

Repeat use of reference characters in the present specification and drawings is intended to represent the same and/or analogous features or elements of the present invention.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to noise reduction in induction heating systems having a quasi-resonant (QR) inverter system. In general, QR induction controls may face difficulties when providing lower wattage continuous power. Accordingly, QR induction controls may include duty cycling to achieve a desired power when at a lower power setting. When the QR induction control starts (e.g., switching device of a QR inverter system begins switching), an inrush current may be applied to a resonant capacitor of the QR inverter system. Specifically, the inrush current may be supplied by a DC bus capacitor that may be directly coupled to the resonant capacitor. This inrush current may cause an undesirable audible ticking noise that may be a nuisance to a user of the induction heating system (e.g., induction cooking appliance). In addition, the inrush current may damage components of the QR inverter system, such as the resonant capacitor.

As such, example aspects of the present disclosure provides an induction heating system for reducing this inrush current and the associated audible noise. For instance, the induction heating system as provided herein may include a QR inverter system and a half-bridge (HB) inverter system. The resonant capacitors within the HB inverter system may be positioned such that an inrush current supplied from the bus capacitor may not affect the resonant capacitors.

As such, the DC bus capacitor may be discharged (e.g., at least partially discharged) by the HB inverter system based on a start-up time of the QR inverter system. For instance, the QR inverter system may be configured to energize a coil beginning at the start-up time. Prior to the start-up time, the HB inverter system may be configured to discharge the DC bus capacitor such that the inrush current applied to the QR inverter system at the start up time may be reduced or eliminated, preventing damage to components (e.g., resonant capacitors) and silencing (e.g., at least partially silencing) audible noise that a user may find to be a nuisance.

Example aspects of the present disclosure provide multiple technical effects and benefits. For example, systems and methods provided herein may reduce inrush current applied to the QR inverter system, reducing audible noise made by the induction heating system while in, for example, a low power mode. In addition, reducing this inrush current may prevent damage to components of the induction heating system, such as the resonant capacitor of the QR inverter system.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (e.g., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

The terms “coupled,” “fixed,” “attached to,” and the like refer to both direct coupling, fixing, or attaching, as well as indirect coupling, fixing, or attaching through one or more intermediate components or features, unless otherwise specified herein.

Except as explicitly indicated otherwise, recitation of a singular processing element (e.g., “a controller,” “a processor,” “a microprocessor,” etc.) is understood to include more than one processing element. In other words, “a processing element” is generally understood as “one or more processing element.” Furthermore, barring a specific statement to the contrary, any steps or functions recited as being performed by “the processing element” or “said processing element” are generally understood to be capable of being performed by “any one of the one or more processing elements.” Thus, a first step or function performed by “the processing element” may be performed by “any one of the one or more processing elements,” and a second step or function performed by “the processing element” may be performed by “any one of the one or more processing elements and not necessarily by the same one of the one or more processing elements by which the first step or function is performed.” Moreover, it is understood that recitation of “the processing element” or “said processing element” performing a plurality of steps or functions does not require that at least one discrete processing element be capable of performing each one of the plurality of steps or functions.

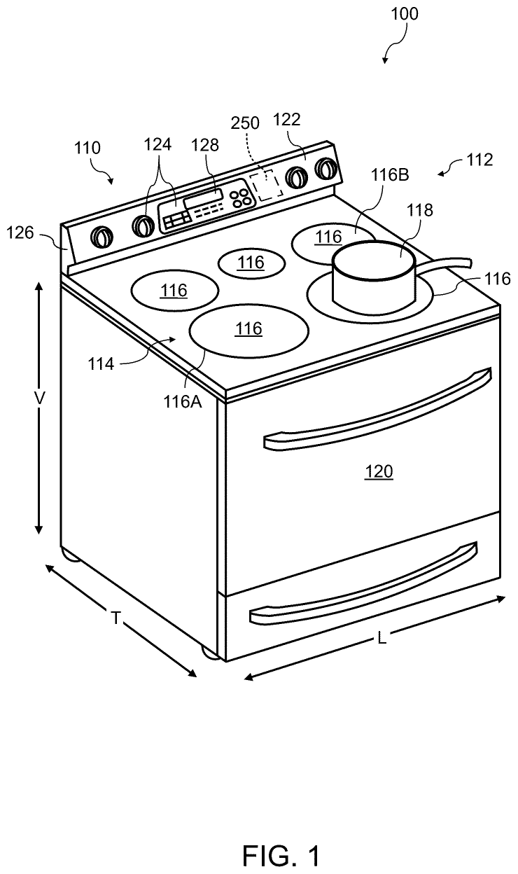

Referring now to the FIGS., FIG. 1 depicts a perspective view of an induction cooking appliance 100. The induction cooking appliance 100 may include a cooktop 112, such as an induction cooktop. Induction cooking appliance 100 is provided by way of example only and is not intended to limit the present subject matter to the arrangement shown in FIG. 1. Thus, the present subject matter may be used with other induction cooking appliances such as oven appliances, single oven range appliances, double oven range appliances, standalone cooktop appliances, cooktop appliances without an oven, etc.

Induction cooking appliance 100 generally defines a vertical direction V, a lateral direction L, and a transverse direction T, each of which is mutually perpendicular, such that an orthogonal coordinate system is generally defined. A cooking surface 114 of cooktop 112 includes one or more induction heating elements 116. As shown in FIG. 1, cooktop 112 may include a plurality of heating elements 116. The heating elements 116 are generally positioned at, e.g., on or proximate to, the cooking surface 114. For the embodiment depicted, the cooktop 112 includes five heating elements 116 spaced along cooking surface 114. However, in other embodiments, the cooktop 112 may include any other suitable shape, configuration, and/or number of heating elements 116. In some embodiments, cooktop 112 may include a combination of other types of heating elements in addition to induction heating elements 116 as shown in FIG. 1. For example, in various embodiments, the cooktop 112 may include any other suitable type of heating elements in addition to the induction heating element, such as a resistive heating element or gas burners, etc.

Each of the induction heating elements 116 may be associated with one or more induction coils configured to inductively heat a load 118. Accordingly, load 118 (e.g., cooking vessel), such as a pot, pan, or the like, may be placed on an induction heating element 116 to heat the load 118 and cook or heat food items placed in load 118. The one or more induction coils of each heating element 116 may be associated with a dedicated inverter system configured to provide an alternating current to energize the one or more coils associated with the heating element 116. In some embodiments, one or more heating elements 116 of induction cooking appliance 100 may be associated with quasi-resonant (QR) inverter systems and one or more other heating elements 116 of induction cooking appliance 100 may be associated with half-bridge (HB) inverter systems. For instance heating element 116A may be associated with a HB inverter system and heating element 116B may be associated with a QR inverter system.

Induction cooking appliance 100 may also include a door 120 that permits access to a cooking chamber (not shown) of induction cooking appliance 100, e.g., for cooking or baking of food items therein. A user interface 122 (e.g., control panel) having user input devices 124 may permit a user to make selections for cooking of food items. Although shown on a backsplash or back panel 126 of induction cooking appliance 100, user interface 122 may be positioned in any suitable location. User input devices 124 may include buttons, knobs, and the like, as well as combinations thereof, and/or user input devices 124 may be implemented on a remote user interface device such as a smartphone, tablet, etc. As an example, a user may manipulate one or more user input devices 124 to select a temperature and/or a heat or power output for each heating element 116. The selected temperature or heat output of heating element 116 affects the heat transferred to load 118 placed on heating element 116. The user interface 122 may also include a display 128.

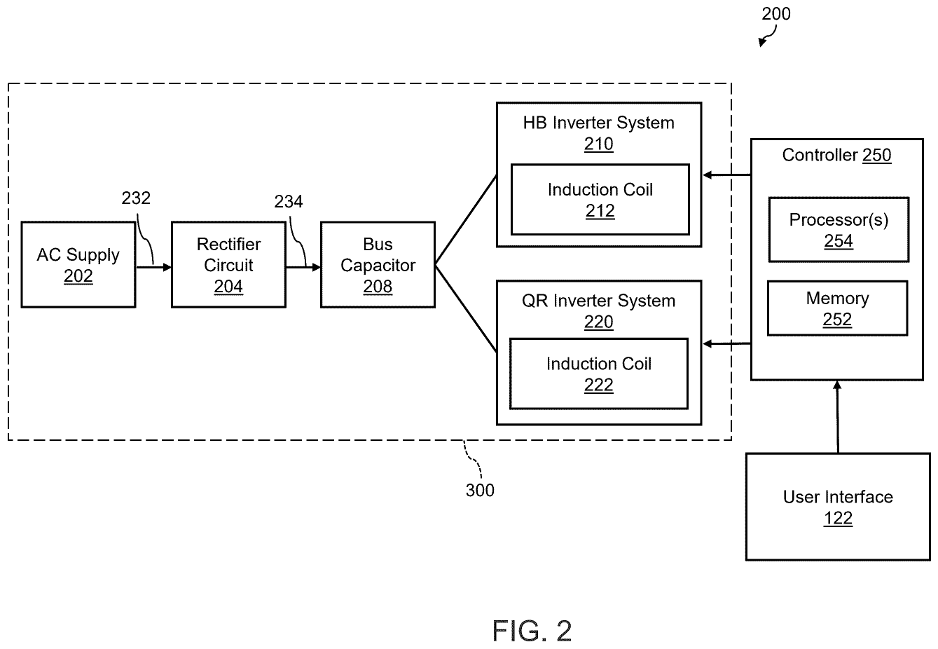

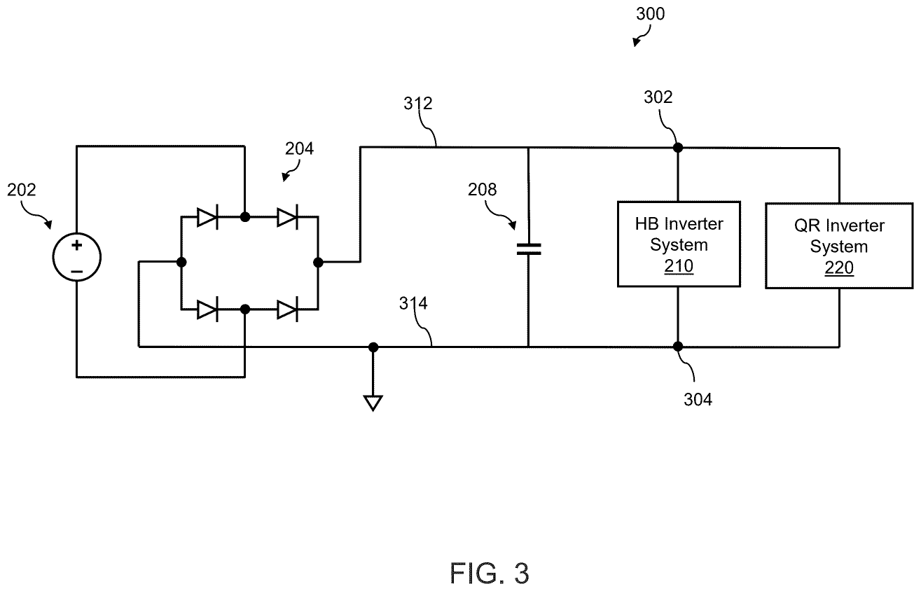

The induction cooking appliance 100 may include a controller 250 for controlling one or more of the plurality of heating elements 116. Specifically, the controller 250 may be operably coupled to the user interface 122 (e.g., user input devices 124 and/or display 128). Controller 250 may be operably coupled to each of the plurality of heating elements 116 for controlling a heating level of each of the plurality of heating elements 116 in response to one or more user inputs received through the user interface 122 and user input devices 124. The controller 250 may also provide output to the display 128, such as an indication of a selected power level, which heating element(s) 116 is or are activated, etc. Furthermore, as will be discussed in greater detail below, the controller 250 may be configured to control operation of an induction heating system such as induction heating system 300 (FIGS. 2-3).

Referring now to FIG. 2, a block diagram depicting an induction heating control system 200 according to example embodiments of the present disclosure is provided. While induction heating control system 200 is discussed with reference to induction cooking appliance 100 of FIG. 1, those of ordinary skill in the art will understand that induction heating control system 200 may be used in any suitable cooking system and/or appliance without deviating from the scope of the present disclosure.

Induction heating control system 200 may include a controller 250 configured to control operation of an induction heating system 300. As shown in FIG. 2, induction heating system 300 generally includes a rectifier circuit 204. Rectifier circuit 204 may receive a line voltage signal 232 (e.g., alternating current (AC) power) from an AC power supply 202, which may provide conventional 60 Hz 120 or 240 volt AC supplied by utility companies. Specifically, rectifier circuit 204 may rectify the line voltage signal 232 from the AC power supply 202 to provide direct current (DC) power 234. In some embodiments, rectifier circuit 204 may include additional circuitry, such as signal filtering and power factor correction circuitry to filter the DC power 234.

Induction heating system 300 further includes bus capacitor 208 (e.g., DC bus capacitor 208). Bus capacitor 208 is coupled to rectifier circuit 204 and configured to receive DC power 234 from rectifier circuit 204. Bus capacitor 208 may be configured in a parallel configuration with rectifier circuit 204. As such, bus capacitor 208 may smooth the voltage of the rectified DC power 234. In some embodiments, DC bus capacitor 208 may have a capacitance that is less than 10 microfarads (μF), such as about 3 μF. As shown in FIG. 2, bus capacitor 208 may be operatively coupled to a plurality of inverter systems, such as a half-bridge (HB) inverter system 210 and a quasi-resonant (QR) inverter system 220.

HB inverter system 210 may be configured to provide an alternating current to first induction coil 212 to energize the coil 212. Specifically, HB inverter system 210 may provide the alternating current based on the DC power 234. For example, HB inverter system 210 may include one or more switching components for converting the DC power 234 to alternating current to energize coil 212. When energized, coil 212 may inductively heat a load, such as load 118 depicted in FIG. 1, positioned proximate coil 212.

Similarly, QR inverter system 220 may be configured to provide an alternating current to second induction coil 222 to energize the coil 222. Specifically, QR inverter system 220 may provide the alternating current based on the DC power 234. For example, QR inverter system 220 may include a switching component (e.g., singular switching component) for converting the DC power 234 to an alternating current to energize coil 222. When energized, coil 222 may inductively heat a load, such as load 118 depicted in FIG. 1, positioned proximate coil 222.

In some embodiments, coil 212 supplied by HB inverter system 210 and QR inverter system 220 may be associated with different heating elements of an induction cooking appliance. For example, HB inverter system 210 may be associated with a first induction heating element of an induction cooking appliance, such as induction heating element 116A of induction cooking appliance 100 depicted in FIG. 1. In addition, coil 222 supplied by QR inverter system 220 may be associated with a second (e.g., different) induction heating element, such as induction heating element 116B of induction cooking appliance 100 depicted in FIG. 1. In some embodiments, induction heating element 116A (FIG. 1) may be a higher power (e.g., higher wattage) heating element than induction heating element 116B (FIG. 1). For instance, HB inverter system 210 may have a higher power setting in comparison to QR inverter system 220 such that an induction heating element 116A (FIG. 1) associated with coil 212 may supply more power to a load 118 (FIG. 1) than heating element 116B (FIG. 1) associated with coil 222.

As shown in FIG. 2, HB inverter system 210 and QR inverter system 220 are each configured to be controlled by a controller 250. Specifically, the switching frequency of the alternating current supplied to the induction coils 212, 222 by the inverter systems 210, 220 may be controlled by controller 250. As shown, controller 250 may be operatively coupled to the inverter systems 210, 220 (e.g., switching devices of inverter systems 210, 220) to control the output power of the associated induction coils 212, 222 by controlling the switching frequency of inverter systems 210, 220. Controller 250 may include a microcontroller and/or gate driver circuitry to drive individual transistors or switching devices of the inverter system 210. In some embodiments, the gate driver circuitry may be an external component to controller 250. For instance, controller 250 may provide switching signals to one or more gate drivers that control the inverter systems 210, 220 based on the switching signals.

While induction heating control system 200 is depicted in FIG. 2 having a singular controller 250 controlling HB inverter system 210 and QR inverter system 220, those of ordinary skill in the art will understand that any number of controllers 250 may be used without deviating from the scope of the present disclosure. For instance, a first controller 250 may be configured to interface (e.g., control) the HB inverter system 210 while a second controller 250 may interface (e.g., control) QR inverter system 220.

As shown, controller 250 may include memory 252 and one or more processors 254 such as microprocessors, CPUs or the like, such as general or special purpose microprocessors operable to execute programming instructions or micro-control code associated with operation of induction cooking appliance 100. Memory 252 may represent random access memory such as DRAM, or read only memory such as ROM or FLASH. In one embodiment, the processor 254 executes programming instructions stored in memory 252. Memory 252 may be a separate component from controller 250 or may be included onboard controller 250.

Controller 250 may be operatively coupled to user interface 122. User interface 122 may allow a user to set a desired power output of an induction coil 212, 222 by, for instance, selecting a power setting from a plurality of user selectable power settings. Controller 250 may control the associated inverter system 210, 220 in an operating mode corresponding to the user selected power setting, such that the coil 212, 222 is energize with the desired power output. Specifically, the inverter system 210, 220 may begin energizing the coil 212, 22 at a start-up time of the inverter system 210, 220 by supplying the alternating current.

For instance, a user may select a low-power setting for induction coil 222 (e.g., induction heating element 116B corresponding to induction coil 222) through user interface 122. As such, controller 250 may control QR inverter system 220 in a low-power mode beginning at a start-up time of the QR inverter system 220, such that coil 222 outputs low-power.

In some embodiments, QR inverter system 220 may include a resonant capacitor that may be damaged by an inrush of current provided by a fully charged bus capacitor 208. Accordingly, a first inverter system (e.g., HB inverter system 210) may be configured to at least partially discharge bus capacitor 208 based at least in part on a start-up time of a second inverter system (e.g., QR inverter system 220). Specifically, controller 250 may control HB inverter system 210 to at least partially discharge bus capacitor 208 based at least in part on a start-up time of QR inverter system 220. The start-up time of the QR inverter system may correspond to when the QR induction control starts, such as when QR inverter system 220 begins energizing coil 222 in an operating mode corresponding to a user selected power setting.

For example, QR inverter system 220 may include a resonant capacitor that is directly coupled with bus capacitor 208. As such, an inrush current may be applied to the resonant capacitor at a start up time of the QR inverter system 220 if the bus capacitor 208 is fully charged. Accordingly, the HB inverter system 210 may at least partially discharge bus capacitor 208 prior to the start up time of the QR inverter system 220.

In some embodiments, controller 250 may be configured to reduce audible noise within induction heating system 300. For instance, the inrush current of a fully charged bus capacitor 208 applied to the QR inverter system 220 may cause an undesirable audible ticking noise that may be a nuisance to a user. At least partially discharging bus capacitor 208 prior to the start up time of the QR inverter system 220 may reduce the inrush of current applied to the QR inverter system 220 at the start up time, reducing audible noise a user may find to be a nuisance.

In some embodiments, the start-up time of QR inverter 220 may correspond to the zero cross of the line voltage signal 232 provided by AC supply 202 to rectifier circuit 204. For instance, QR inverter system 220 may begin energizing coil 222 at a time corresponding to the time that line voltage signal 232 switches from a first voltage polarity to a second voltage polarity (e.g., from a positive voltage to a negative voltage or from a negative voltage to a positive voltage).

FIG. 3 provides a schematic implementation of induction heating system 300 according to example embodiments of the present disclosure. As shown, induction heating system 300 may include an AC power supply 202 operatively coupled to a rectifier circuit 204. As shown in FIG. 3, rectifier circuit 204 may be a full-wave rectifier that includes four diodes. Rectifier circuit 204 may provide DC power from the line voltage signal received from AC power supply 202. DC bus capacitor 208 may receive the DC power from rectifier circuit 204. Specifically, bus capacitor 208 may be coupled to the rectifier circuit 204 in a parallel configuration.

As shown in FIG. 3, bus capacitor 208 may be operatively coupled to rectifier 204 by a high-side path 312 and a low-side path 314. In some embodiments, high-side path 312 may be defined by a bus voltage, which is supplied to bus capacitor 208 by rectifier 204. Low-side path 314 may be defined by a ground supplied to low-side path 314. Both the HB inverter system 210 and the QR inverter system 220 may be connected in a parallel configuration with bus capacitor 208. For instance, bus capacitor 208, HB inverter system 210, and QR inverter system 220 may share a first node 302 on high-side path 312 and a second node 304 on low-side path 314. As such, HB inverter system 210 and QR inverter system 220 may both be connected in parallel with bus capacitor 208.

While the induction heating system 300 of FIG. 3 is depicted with one HB inverter system 210 and one QR inverter system 220, those of ordinary skill in the art will understand that induction heating system 300 may include any suitable number of HB inverter systems 210 and QR inverter systems 220 connected in parallel with bus capacitor 208 without deviating from the scope of the present disclosure.

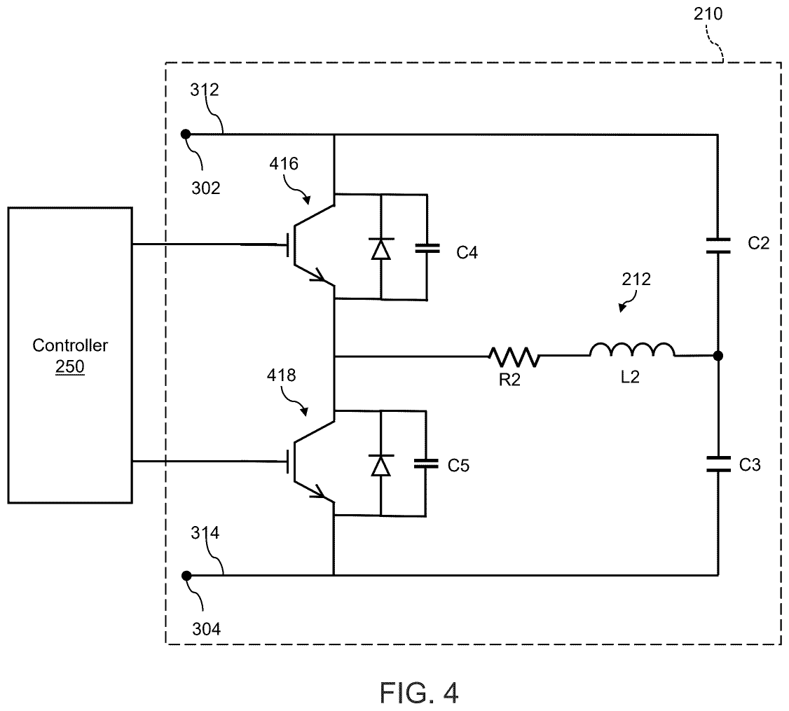

Referring now to FIG. 4, a schematic implementation of an example HB inverter system 210 is provided according to example embodiments of the present disclosure. As shown in FIG. 4, HB inverter system 210 may include a half-bridge (HB) inverter architecture configured to energize an induction coil 212 to inductively heat a load. As depicted in FIG. 4, induction coil 212 and, if present, a load (e.g., load 118 as shown in FIG. 1) may be represented (e.g., modeled) in FIG. 4 as an inductor L2 (e.g., coil 212) and a resistor R2 (e.g., load). As shown, induction coil 212 may be coupled to high-side switching device 416 and low-side switching device 418 of the inverter system 210. Specifically, inverter system 210 may be a half-bridge resonant inverter system with switching devices 416, 418 on one side of the coil 212 and resonant capacitors C2, C3 on the other side of the coil 212.

Switching devices 416, 418 may provide the alternating current to the induction coil 212 at a desired frequency set by, for example, controller 250. As shown, controller 250 may be operatively coupled to inverter system 210 at high-side switching device 416 and low-side switching device 418. In some embodiments, switching devices 416, 418 may be Insulated-Gate Bipolar Transistors (e.g., IGBTs). However, other suitable switching devices (e.g., MOSFETs) may be used without deviating from the scope of the present disclosure. Switching devices 416, 418 may be configured in parallel with feedback diodes and capacitors (e.g., snubber capacitors) C4 and C5 respectively.

Inverter system 210 may be a resonant inverter system having one or more resonant capacitors C2, C3. As shown in FIG. 4, the one or more resonant capacitors may include a high-side resonant capacitor C2 and a low-side resonant capacitor C3. As previously described with reference to FIGS. 2-3, inverter system 210 may be operatively coupled to bus capacitor 208 (FIGS. 2-3) by high-side path 312 and a low-side path 314. Specifically, inverter system 210 may be operatively coupled to bus capacitor 208 at first node 302 on high-side path 312 and second node 304 on low-side path 314.

As previously described, HB inverter system 210 may be configured to at least partially discharge bus capacitor 208 (FIG. 3). HB inverter system 210 may at least partially discharge bus capacitor 208 (FIG. 3) through the first coil 212. For instance, switching devices 416, 418 may be controlled by, for instance, controller 250 to perform a short pulse to discharge bus capacitor 208 (FIG. 3) with first coil 212. Specifically, switching devices 416, 418 may be controlled such that power stored on the bus capacitor 208 (FIG. 3) may be discharged through coil 212 with a short pulse.

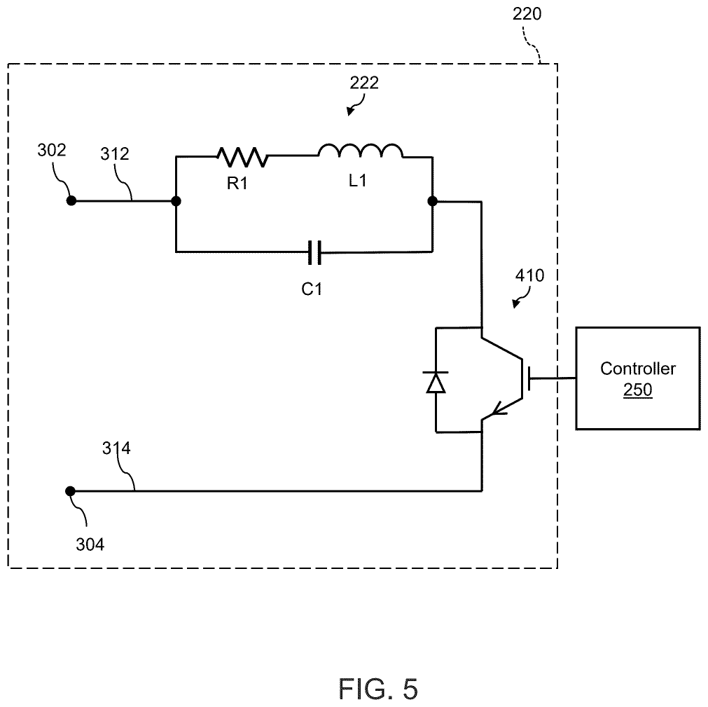

FIG. 5 provides a schematic implementation of an example QR inverter system 220 according to example embodiments of the present disclosure. As shown in FIG. 5, QR inverter system 220 may include a quasi-resonant (QR) inverter architecture configured to energize a coil 222 to inductively heat a load, such as a load 118 depicted in FIG. 1.

As depicted in FIG. 5, QR inverter system 220 may include a resonant capacitor C1 that forms a resonant tank with induction coil 222. Specifically, induction coil 222 and, if present, a load (e.g., load 118 as shown in FIG. 1) may be represented (e.g., modeled) in FIG. 5 as an inductor L1 and a resistor R1.

QR inverter system 220 may be operatively coupled to the bus capacitor 208 (FIG. 3) in a parallel configuration. For instance, inverter system 220 may be operatively coupled to bus capacitor 208 (FIGS. 2-3) by high-side path 312 and a low-side path 314. Specifically, inverter system 220 may be operatively coupled to bus capacitor 208 at first node 302 on high-side path 312 and second node 304 on low-side path 314.

QR inverter system 220 may provide an alternating current to induction coil 222 at the start-up time of QR inverter system 220. For instance, QR inverter system 220 may include a singular QR switching device 410. QR switching device 410 may supply coil 222 with an alternating current beginning at a start-up time of the QR inverter system 220. The alternating current may be set at a desired frequency by, for example, controller 250. Accordingly, controller 250 may be operatively coupled to QR switching device 410.

Controller 250 may control the switching frequency of QR switching device 410 and hence the output power of coil 222 based on a user selected power setting. In some embodiments, QR inverter system 220 may be controlled in a low-power mode. To provide continuous power to coil 222 in the low-power mode, QR switching device 410 may be duty cycled by rapidly pulsing power to coil 222. In such an embodiment, bus capacitor 208 (FIG. 3) may be at least partially discharged prior to each start-up time of QR inverter system 220 (e.g., each time QR switching device switches from an OFF state to an ON state).

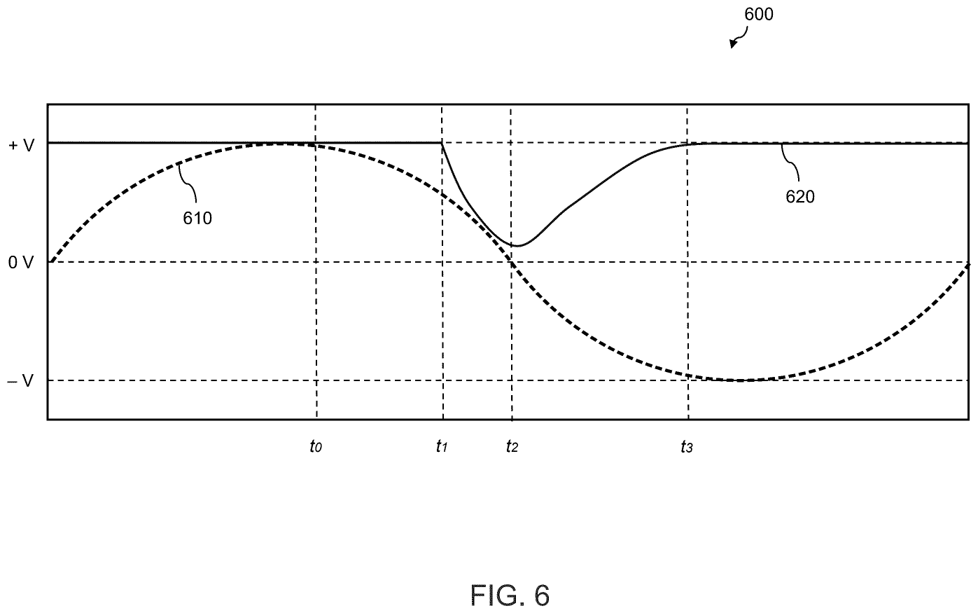

FIG. 6 depicts a graphical representation of example signals of an induction heating system according to example embodiments of the present disclosure. Specifically, FIG. 6 is described with reference to induction heating system 300 shown in FIGS. 2-3.

As shown, plot 600 depicts an example line signal voltage 610, such as line voltage signal 232 described with reference to FIG. 1, over a time period. Plot 600 further depicts an example bus voltage signal 620 indicating the voltage across bus capacitor 208 over the same time period. Bus voltage signal 620 may also indicate the voltage across HB inverter system 210 and QR inverter system 220. For instance, bus voltage signal 620 may indicate the voltage from node 302 on high-side path 312 to node 304 on low-side path as depicted in FIG. 3.

As previously described HB inverter system 210 may be configured to at least partially discharge bus capacitor 208 based at least in part on a start-up time of QR inverter system 220. As shown in plot 600 at t₀, bus capacitor 208 may be fully charged prior to the start-up time (t₂) of QR inverter 220. At t₁, begins to discharge the bus capacitor 208. As shown, the bus capacitor is discharged from t₁ until the start-up time (t₂). At the start-up time (t₂), bus capacitor 208 is at least partially discharged such that the inrush current supplied to the QR inverter system 220 is reduced in comparison to starting up with a fully charged bus capacitor 208. Bus capacitor 208 may then recharge from the start-up time (t₂) until t₃ when bus capacitor 208 is again fully charged.

As shown, the start-up time (t₂) of the QR inverter system 220 may correspond to a zero cross of line voltage signal 610. For instance, line voltage signal 610 may cross from a first voltage polarity (e.g., positive voltage) to a second voltage polarity (e.g., negative voltage) at the start-up time (t₂).

In some embodiments, the example signals of FIG. 6 may be provided by an induction heating system such as induction heating system 300 of FIGS. 2-3 when the QR inverter system 220 is operating in a low-power mode. For instance, controller 250 may control QR inverter system 220 in the low-power mode beginning at the start-up time (t₂). Prior to the start-up time (t₂), controller 250 may control HB inverter system 210 to discharge bus capacitor 208 beginning at t₁ such that bus capacitor 208 is at least partially discharged at the start-up time (t₂).

One example aspect of the present disclosure is directed to an induction heating system for an induction cooking appliance. The induction heating system includes a bus capacitor configured to receive direct current (DC) power. The induction heating system further includes a first inverter system operatively coupled to the bus capacitor, the first inverter system configured to energize a first coil based at least in part on the DC power. The induction heating system further includes a second inverter system operatively coupled to the bus capacitor, the second inverter system configured to energize a second coil based at least in part on the DC power. The first inverter system is further configured to at least partially discharge the bus capacitor based at least in part on a start-up time of the second inverter system.

In some examples, the first inverter system is configured to at least partially discharge the bus capacitor prior to the start-up time of the second inverter system.

In some examples, the first inverter system is configured to at least partially discharge the bus capacitor through the first coil.

In some examples, the first inverter system and the second inverter system are connected in parallel with the bus capacitor.

In some examples, the second inverter system is a quasi-resonant (QR) inverter system.

In some examples, the first inverter system is a half-bridge (HB) inverter system.

In some examples, the first inverter system is configured to at least partially discharge the bus capacitor based at least in part on the start-up time when the second inverter system is operating in a low-power mode.

In some examples, the first coil is associated with a first induction heating element of the induction cooking appliance and the second coil is associated with a second induction heating element of the induction cooking appliance.

In some examples, the induction heating system further includes a rectifier circuit configured to provide the DC power from a line voltage signal received from an alternating current (AC) power supply. In some examples, the start-up time of the second inverter system corresponds to a zero cross of the line voltage signal.

Another example aspect of the present disclosure is directed to an induction heating system for an induction cooking appliance. The induction heating system includes a bus capacitor configured to receive direct current (DC) power. The induction heating system further includes a half-bridge (HB) inverter system operatively coupled to the bus capacitor, the HB inverter system configured to energize a first coil based at least in part on the DC power. The induction heating system further includes a quasi-resonant (QR) inverter system operatively coupled to the bus capacitor, the QR inverter system configured to energize a second coil based at least in part on the DC power. The HB inverter system is further configured to at least partially discharge the bus capacitor based at least in part on a start-up time of the QR inverter system.

In some examples, the HB inverter system is configured to at least partially discharge the bus capacitor prior to the start-up time of the QR inverter system.

In some examples, the HB inverter system and the QR inverter system are connected in parallel with the bus capacitor.

In some examples, the HB inverter system is configured to at least partially discharge the bus capacitor based at least in part on the start-up time when the QR inverter system is operating in a low-power mode.

Another example aspect of the present disclosure is directed to an induction cooking appliance. The induction cooking appliance includes one or more induction heating elements. The induction cooking appliance further includes an induction heating system. The induction heating system includes a bus capacitor configured to receive direct current (DC) power. The induction heating system further includes a first inverter system operatively coupled to the bus capacitor, the first inverter system configured to energize a first coil based at least in part on the DC power. The induction heating system further includes a second inverter system operatively coupled to the bus capacitor, the second inverter system configured to energize a second coil based at least in part on the DC power. The first inverter system is further configured to at least partially discharge the bus capacitor based at least in part on a start-up time of the second inverter system.

In some examples, the first inverter system is configured to at least partially discharge the bus capacitor prior to the start-up time of the second inverter system.

In some examples, the first inverter system is configured to at least partially discharge the bus capacitor through the first coil.

In some examples, the first inverter system and the second inverter system are connected in parallel with the bus capacitor.

In some examples, the second inverter system is a quasi-resonant (QR) inverter system.

In some examples, the first inverter system is a half-bridge (HB) inverter system.

In some examples, the one or more induction heating elements comprises a first induction heating element and a second induction heating element, wherein the first coil is associated with the first induction heating element and the second coil is associated with the second induction heating element.

While the present subject matter has been described in detail with respect to specific example embodiments thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. An induction heating system for an induction cooking appliance, the induction heating system comprising:
a bus capacitor configured to receive direct current (DC) power;
a first inverter system operatively coupled to the bus capacitor, the first inverter system configured to energize a first coil based at least in part on the DC power; and
a second inverter system operatively coupled to the bus capacitor, the second inverter system configured to energize a second coil based at least in part on the DC power,
wherein the first inverter system is further configured to at least partially discharge the bus capacitor based at least in part on a start-up time of the second inverter system.

2. The induction heating system of claim 1, wherein the first inverter system is configured to at least partially discharge the bus capacitor prior to the start-up time of the second inverter system.

3. The induction heating system of claim 2, wherein the first inverter system is configured to at least partially discharge the bus capacitor through the first coil.

4. The induction heating system of claim 1, wherein the first inverter system and the second inverter system are connected in parallel with the bus capacitor.

5. The induction heating system of claim 1, wherein the second inverter system is a quasi-resonant (QR) inverter system.

6. The induction heating system of claim 5, wherein the first inverter system is a half-bridge (HB) inverter system.

7. The induction heating system of claim 1, wherein the first inverter system is configured to at least partially discharge the bus capacitor based at least in part on the start-up time when the second inverter system is operating in a low-power mode.

8. The induction heating system of claim 1, wherein the first coil is associated with a first induction heating element of the induction cooking appliance and the second coil is associated with a second induction heating element of the induction cooking appliance.

9. The induction heating system of claim 1, further comprising:
a rectifier circuit configured to provide the DC power from a line voltage signal received from an alternating current (AC) power supply,
wherein the start-up time of the second inverter system corresponds to a zero cross of the line voltage signal.

10. An induction heating system for an induction cooking appliance, the induction heating system comprising:
a bus capacitor configured to receive direct current (DC) power;
a half-bridge (HB) inverter system operatively coupled to the bus capacitor, the HB inverter system configured to energize a first coil based at least in part on the DC power; and
a quasi-resonant (QR) inverter system operatively coupled to the bus capacitor, the QR inverter system configured to energize a second coil based at least in part on the DC power,
wherein the HB inverter system is further configured to at least partially discharge the bus capacitor based at least in part on a start-up time of the QR inverter system.

11. The induction heating system of claim 10, wherein the HB inverter system is configured to at least partially discharge the bus capacitor prior to the start-up time of the QR inverter system.

12. The induction heating system of claim 10, wherein the HB inverter system and the QR inverter system are connected in parallel with the bus capacitor.

13. The induction heating system of claim 10, wherein the HB inverter system is configured to at least partially discharge the bus capacitor based at least in part on the start-up time when the QR inverter system is operating in a low-power mode.

14. An induction cooking appliance, comprising:
one or more induction heating elements;
an induction heating system, comprising:
a bus capacitor configured to receive direct current (DC) power;
a first inverter system operatively coupled to the bus capacitor, the first inverter system configured to energize a first coil based at least in part on the DC power; and
a second inverter system operatively coupled to the bus capacitor, the second inverter system configured to energize a second coil based at least in part on the DC power,
wherein the first inverter system is further configured to at least partially discharge the bus capacitor based at least in part on a start-up time of the second inverter system.

15. The induction cooking appliance of claim 14, wherein the first inverter system is configured to at least partially discharge the bus capacitor prior to the start-up time of the second inverter system.

16. The induction cooking appliance of claim 14, wherein the first inverter system is configured to at least partially discharge the bus capacitor through the first coil.

17. The induction cooking appliance of claim 14, wherein the first inverter system and the second inverter system are connected in parallel with the bus capacitor.

18. The induction cooking appliance of claim 17, wherein the second inverter system is a quasi-resonant (QR) inverter system.

19. The induction cooking appliance of claim 18, wherein the first inverter system is a half-bridge (HB) inverter system.

20. The induction cooking appliance of claim 14, wherein the one or more induction heating elements comprises a first induction heating element and a second induction heating element, wherein the first coil is associated with the first induction heating element and the second coil is associated with the second induction heating element.
